(19) United States
(12) Patent Application Publication
(10) Pub. No.: US 2005/0158585 A1
(43) Pub. Date: Jul. 21, 2005

(54) Vertical magnetic recordding medium magnetic recorder having same vertical magnetic recording medium manufacturing method and vertical magnetic recording medium manufacturing apparatus

(76) Inventors: Migaku Takahashi, Miyagi (JP); Shin Saito, Miyagi (JP); David Djayaprawira, Miyagi (JP)

Correspondence Address: ROSSI & ASSOCIATES, P.O. BOX 826, ASHBURN, VA, 20146-0826, US

(21) Appl. No.: 10/509,244

(22) PCT Filed: Mar. 20, 2003
(86) PCT No.: PCT/JP03/03439

(30) Foreign Application Priority Data
Mar. 28, 2002 (JP) 2002-092371

(51) Int. Cl. G11B 5/667; B05D 5/12

(52) U.S. Cl. 428/694 T; 428/336; 427/128

(57) ABSTRACT

A vertical magnetic recording medium has a low-noise characteristic compared to media of a permalloy or sendust crystalline material, including a high-flatness soft magnetic backing layer, and enabling recording/reproduction of information at high recording density, a magnetic recorder provided with the vertical magnetic recording medium, a vertical magnetic recording medium manufacturing method and apparatus. The vertical magnetic recording medium has a multilayer structure on a substrate, in which a soft magnetic backing layer, a vertical recording layer of a ferromagnetic body, and a protective layer are formed. The soft magnetic backing layer is formed of an FeSiAlN film of a soft magnetic material. The atom % of each element of Fe, Si, Al, and N of the FeSiAlN film can be changed by changing the flow rate of N2 gas in a mixture gas of N2 gas and Ar gas introduced into the chamber.

### TECHNICAL FIELD

The present invention relates to a perpendicular recording medium, a magnetic recorder having the same, the method and apparatus for producing the perpendicular recording medium, and more specially to the construction of a perpendicular recording medium suitably used for hard disks, magnetic tapes and other magnetic recording media, capable of realizing a higher saturation magnetization, low noises, a high density and yet capable of coping with a low-temperature process, a magnetic recording apparatus having the same, as well as the method and apparatus of producing such perpendicular recording medium.

### BACKGROUND ART

The magnetic recording media used in the conventional hard disc drives (HDD) and other magnetic recording apparatuses adopt the longitudinal recording method by which the magnetization direction is fixed in the in-plane direction of magnetic recording layer and data are recorded by reversing this magnetization. In order to increase the recording density per unit area by this method, efforts have been made to develop recording media that allow mainly shortening the length of magnetization reversal direction, or improvement of linear recording density.

It has been known that an effective method of increasing the linear recording density of longitudinal recording media is to shorten the length of magnetization reversal. And in order to address to the improvement of linear recording density, the medium is required to have a greater coercive force of the ferromagnetic metal layer, a lower residual flux density and a reduced thickness of the ferromagnetic metal layer.

However, any thinning of the film thickness of the ferromagnetic metal layer for the purpose of increasing its linear recording density results in a smaller dimension of the magnetic crystal grain that constitutes the ferromagnetic layer and therefore a reduction of its volume V. And when KᵤV., the product of the anisotropy constant Kᵤ of the magnetic crystal grain multiplied by its volume becomes smaller than a certain level, it is feared that under the impact of heat the magnetizing orientation of magnetic crystal grains would become unstable leading to the development of a thermal fluctuation phenomenon or the problem of so-called thermal decay.

Since this thermal fluctuation phenomenon becomes all the more apparent as the volume V of the magnetic crystal grain is smaller, a magnetic material having a high Ku is necessary in order to secure the thermal stability of magnetic recording.

On a magnetic recording medium of this longitudinal recording system, the measure taken for increasing the plane recording density consisted of enhancing the coercive force of the ferromagnetic metal layer. However, an excessively strong coercive force brings about the possibility of inhibiting data from being written by a cylinder head and other harmful effects of an improved coercive force. On the other hand, according to the perpendicular recording method wherein a recording head in the form of a bar magnet called “single pole head” is used to record data by reversing magnetization vertically to the in-plane of the medium, it is possible to record even on media having a high coercive force, and therefore a plane recording density equal to or higher than the longitudinal recording method can be obtained. Accordingly, various research and development activities have been undertaken.

Even when the crystal grain size of the ferromagnetic metal layer is reduced, this perpendicular recording method can maintain the volume V of the crystal grain in the thickness direction provided an appropriate thickness is maintained. And thus it becomes easier to maintain the thermal stability of the magnetizing orientation of magnetic crystal grains. Because of this characteristic, this method is noted as an art capable of avoiding the problem of thermal decay feared in the conventional longitudinal recording method.

As a perpendicular recording medium applicable to such a perpendicular recording system, a double-layered film medium having a soft magnetic film easily magnetizable in the in-plane direction between the substrate and the perpendicular recording layer has been proposed. (Reference: S. Iwasaki, Y Nakamura and K. Ouchi: IEEE Trans. Magn. MAG-15 (1979) 1456).

This soft magnetic film, wherein permalloy crystalline materials represented by NiFe alloys, Sendust (a FeSiAl alloy) crystalline materials or non-crystalline materials such as CoZrNb are preferably used, is thicker by ten (10) times or more than the ferromagnetic metal layer constituting the perpendicular recording layer.

This double-layered medium enables to write in a perpendicular recording layer having a greater coercive force than a single-layered medium constituted only by a perpendicular recording layer and is capable of increasing reproduction voltage. In addition, it is characterized in that the soft magnetic film converges the magnetic flux generated by the main magnetic pole of the magnetic head to a high density in a space at the top of the main magnetic pole and results in an intensification of the magnetic field around the main magnetic pole (Reference: Shun-ichi Iwasaki and Shinji Tanabe, Journal of the Institute of Electronics, Information and Communication Engineers, J66-C 740 (1983)).

However, this double-layered medium, for example the permalloy crystalline materials had a problem in that the structure factor S serving as the index of dispersion (skew) of local magnetization is extremely small and therefore a large number of 180° domain wall structures are formed within the soft magnetic film. As a result, the magnetic flux leakage from these domain walls resulted in frequent spike noises.

In addition, this normal production process of depositing such permalloy crystalline materials by means of a sputtering device had a problem in that the surface of thin films becomes rough due to the initial island-like growth mode of crystal grains and cyclical noises occur due to the magnetic flux leakage from magnetic pole resulting from this rough part.

Thus, the noises resulting from a soft magnetic film having a thickness ten times or more greater than the ferromagnetic layer which is a perpendicular recording layer on the double-layered film media have been an important problem. And the development of a material having a higher saturation magnetization has been desired to make this soft magnetic film thinner.

Lately, therefore, a soft magnetic material of the nanocrystalline precipitated type wherein nanoncrystalline grains are precipitated inside by heating an amorphous film after deposition has been proposed as a low-noise soft magnetic film. (References: Atsushi Kikukawa, Yukio Honda, Yosiyuki Hirayama and Masaaki Futamoto: IEEE Trans. Magn., Vol 36, No. 3, SEP (2000) 2402).

And the inventors of the present invention revealed that FeTaN, a soft magnetic material comprising precipitated nanocrystalline microstructure, is promising as a low-noise underlayer material having a high saturation magnetization (Japanese Patent Application 2001-288835).

Despite a lower level of noises it generates as compared with the conventional double-layered medium, because of the production process in which a non-crystalline film made by deposition is heated at a temperature of more than 350° C. to precipitate a fine crystalline grain inside, said soft magnetic material comprising precipitated nanocrystalline microstructure had a problem of difficulty in controlling with a high precision the grain diameter of the precipitated crystal grain on the whole disk.

And after the depositing step it is necessary to provide a step of heating at a high temperature and a step of cooling down for forming a precipitated texture. Thus, it is feared that this increase in the number of steps would result in a reduced product yield and thus constitute a factor of increasing the production cost.

The present invention was made in order to solve the above problems, and therefore it is an object of the present invention to provide a perpendicular recording medium having a low noise characteristic as compared with permalloy or sendust crystalline materials, having a notably flat soft magnetic underlayer (hereinafter referred to as “SUL”) and capable of recording and reproducing information at a high recording density.

Another object of the present invention is to provide a magnetic recording apparatus provided with a perpendicular recording medium having said outstanding low-noise characteristic.

Another object of the present invention is to provide a method of producing perpendicular recording media wherein perpendicular recording media having said outstanding low-noise characteristic can be efficiently produced.

A further object of the present invention is to provide a production apparatus of perpendicular recording media capable of producing efficiently perpendicular recording media having said outstanding low-noise characteristic.

### DISCLOSURE OF THE INVENTION

In order to solve said problems, the present invention adopted the following perpendicular recording medium, the magnetic recording apparatus having the same and the method and apparatus for producing the perpendicular recording media.

The perpendicular recording medium of the present invention comprises a SUL and a perpendicular recording layer formed on said SUL, said SUL consisting of a soft magnetic material composed of FeSiAlN.

This perpendicular recording medium wherein the SUL of a double-layered medium consisting of a SUL and a perpendicular recording layer is made of a soft magnetic material composed of FeSiAlN can realize a low noise level in comparison with the conventional permalloy or sendust crystalline materials and can record and reproduce information at a high recording density.

In the perpendicular recording medium of the present invention, it is preferable that said soft magnetic material contains 5-11 atomic % of N.

In addition, it is preferable that said soft magnetic material contains 69-85 atomic % of Fe, 5-10 atomic % of Si and 5-10 atomic % of Al.

In the perpendicular recording medium of the present invention, FeSiAiN of the composition as described above can be used as a soft magnetic material to constitute a SUL of a uniform nanocrystalline structure consisting of fine crystal grains of Fe group, crystal grains of silicone nitride and aluminum nitride of a nm order to realize an outstanding low-noise characteristic and enable to record and reproduce information at a higher recording density.

Furthermore, the perpendicular recording medium of the present invention is characterized in that the average diameter of the grains of said SUL is 7 nm or less.

And said SUL is characterized in that the banded magnetic domain stabilization energy obtained from the hysteresis curve of its magnetic property is 1×10³ erg/cm³ or less.

And said SUL is characterized in that its surface roughness is 0.6 nm or less when its film thickness is in the range of 50-500 nm.

The magnetic recording apparatus of the present invention comprises a perpendicular recording medium according to the present invention.

The magnetic recording apparatus, provided with a perpendicular recording medium of an outstanding low-noise characteristic, can provide a magnetic recording apparatus capable of recording and reproducing information at high recording density.

The production method of perpendicular recording media according to the present invention is a production method of perpendicular recording media comprising a SUL and a perpendicular recording layer formed above said SUL wherein the process of forming said SUL comprises a process of depositing a base material containing at least Fe, Si and Al and an inert gas including nitrogen (N₂) gas on the substrate the surface temperature of which is kept not higher than 200° C.

In this production method of perpendicular recording media, the adoption of a process of forming said SUL by depositing a base material containing at least Fe, Si and Al and an inert gas including nitrogen (N₂) gas on the substrate the surface temperature of which is kept not higher than 200° C. leads to the deposition of a SUL of a uniform crystalline structure consisting of fine crystal grains of a nm order on the substrate. There is no need to proceed to thermal processing after the deposition, and in this way perpendicular recording media having an outstanding low-noise property is obtained.

The production apparatus of perpendicular recording media of the present invention is a production apparatus of perpendicular recording media consisting of a SUL and a perpendicular recording layer formed above said SUL comprising a deposition chamber or chambers for depositing said SUL on the substrate the surface temperature of which is kept not higher than 200° C. by introducing a base material containing at least Fe, Si and Al and an inert gas containing nitrogen (N₂) gas.

In this production apparatus of perpendicular recording media comprising a deposition chamber or chambers for depositing said SUL on the substrate the surface temperature of which is kept not more than 200° C. by introducing a base material containing at least Fe, Si and Al and an inert gas containing nitrogen (N₂) gas, by controlling the flow rate of the inert gas including nitrogen (N₂) gas introduced into said deposition chamber, the content ratio (atomic %) of N contained in FeSiAiN constituting the SUL can be controlled with a high precision within the limits of composition of materials for creating an outstanding low-noise property.

In this way, a SUL containing FeSiAlN and having an outstanding low-noise property can be obtained easily and with a good reproducibility.

### BRIEF DESCRIPTION OF DRAWINGS

FIG. 1 is a cross-sectional view showing the perpendicular recording medium according an embodiment of the present invention.

FIG. 2 is a three-dimensional view showing the relationship between the composition and magnetic permeability of the FeSiAl alloy.

FIG. 3 is a graph describing the three-dimensional state of the FeSiAl alloy.

FIG. 4 is a cross-sectional view showing the spattering apparatus of a mode of carrying out of the present invention.

FIG. 5 is a cross-sectional view showing the first deposition chamber of the spattering apparatus of a mode of carrying out of the present invention.

FIG. 6 is a graph showing the measurement of the magnetization curve of the Embodiment 1 of the present Invention.

FIG. 7 is a graph showing the measurement of the magnetization curve of the Embodiment 2 of the present Invention.

FIG. 8 is a graph showing the measurement of the magnetization curve of the Embodiment 3 of the present Invention.

FIG. 9 is a graph showing the measurement of the magnetization curve of a comparative example.

FIG. 10 is a graph describing the method of calculating the stabilization energy from the magnetization curve of the SUL.

FIG. 11 is a cross-sectional view showing an integral read-write film head used for the measurement of medium noises.

FIG. 12 is a graph showing the measurement of the noises of the sample of the embodiment 3 of the present invention.

FIG. 13 is a graph showing the measurement of the noises of the sample of a comparative example.

FIG. 14 is a cross-sectional view of the magnetic recording apparatus of a mode of carrying out of the present invention.

FIG. 15 is a plane view of the magnetic recording apparatus of a mode of carrying out of the present invention.

### DESCRIPTION OF CODES

1. Perpendicular recording medium

2. Substrate

3. SUL

4. Perpendicular recording layer

5. Protective layer

11. Spattering apparatus (production apparatus)

13. First deposition chamber

15. Second deposition chamber

21. Chamber (deposition chamber)

25. Apparatus for the introduction of mixed gas

50. Magnetic head

70. Hard disk drive (magnetic recording apparatus)

72. Perpendicular recording medium

### BEST MODE FOR CARRYING OUT THE INVENTION

A mode for carrying out the perpendicular recording medium and the magnetic recording apparatus having the same as well as the method and apparatus for producing the perpendicular recording medium according to the present invention will be described below with reference to drawings. These modes for carrying out, however, will be described specifically so that the readers may be able to understand better the purport of the invention. Therefore, they are not intended to limit the present invention unless specially specified otherwise.

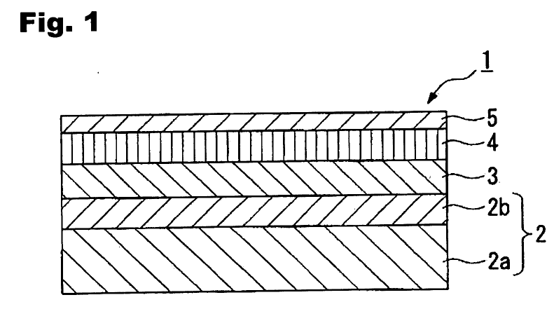

FIG. 1 is a cross sectional view of the perpendicular recording medium according to a mode of carrying out of the present invention as applied to a hard disk of a computer.

This perpendicular recording medium 1 is made by laminating a substrate 2, a SUL 3, a perpendicular recording layer 4 made of a ferromagnetic substance and a protective layer 5 upward in the order indicated above.

The substrate 2 is formed by covering the base substrate 2a made of a discoidal non-magnetic substance with a coating layer 2b made of a non-magnetic material different from said base substrate 2a.

The base substrate 2a comprises, for example, alminum or titanium or its alloys, silicon, glass, carbon, ceramics, plastics, resin or any composite thereof.

The coating layer 2b is made of a non-magnetic material that does not magnetize at high temperatures, a good conductor of electricity, a good conductor of heat, is easily machineable and yet has an adequate surface hardness.

As non-magnetic materials meeting these conditions, there are NiP, NiTa, NiAl, NiTi, etc. which can be formed by the spattering, deposition and electroplating methods.

Generally, in the case of perpendicular recording media, it is desirable that the gap between the magnetic head and the perpendicular recording medium be kept small to enable the magnetic head read well signals written in said perpendicular recording medium. When the magnetic head records and reproduces by flying above the perpendicular recording medium in particular, the flying height should be kept as small as possible. It is more desirable that the magnetic head remain in contact if possible with the surface of the perpendicular recording medium in place of flying above the same while recording and reproducing. Therefore, as materials for the substrate of the perpendicular recording medium, it is preferable to adopt those having a good surface flatness. Moreover, it is preferable to adopt a substrate wherein the parallelism of both sides, circumferential swell and the surface roughness are adequately controlled.

Preferable forms of the substrate 2 from the above viewpoints include, for example, a glass base substrate, a silicon base substrate, an aluminum base substrate and other base substrates with a good surface flatness covered with a coating layer 2b made of a NiP layer, a NiTa layer, a NiAl layer or a NiTi layer. The glass base substrate is particularly preferable because it is hard enough to make base substrate thin.

This substrate 2 may be provided with a buffer layer for creating unevenness on its surface layer in order to improve friction or abrasion when the surface of the perpendicular recording medium 1 and that of the magnetic head get into contact or slide during recording or reproducing.

And this substrate 2 may comprise a seed layer in the form of not a two-dimensional flat film but in the form of a film of locally scattered islands as a layer constituting the nucleus for promoting the growth of crystals in the initial stage of growth of crystal grains forming part of the perpendicular recording layer 4 and the like to be accumulated thereon. Such a seed layer can realize the miniaturization of the crystal grains constituting stratified films formed thereon and reduce the grain size dispersion thereof (See Japanese Patent Application 11-150424).

Furthermore, as a countermeasure for the contact and sliding between the surfaces of the perpendicular recording medium 1 and the magnetic head when the substrate 2 rotates and/or stops (Contact Start Stop, CSS), roughly concentric slight textures may be created on the surface of the substrate 2 in the same way as the substrate for the conventional in-plane magnetic recording medium.

The SUL 3 has a film thickness of 50-500 nm and consists of a soft magnetic material having a composition of FeSiAlN. By adopting a FeSiAlN film, this SUL 3 raised its saturation magnetization as compared with the conventional permalloy, sendust or other crystalline materials for the underlayer and acquired a low-noise characteristic of more or less equal level as FeTaC or FeTaN which are nanocrystalline precipitated texture type materials for the underlayer. Thus, by adopting a SUL 3 of said composition, it is possible to compose easily a perpendicular recording medium enjoying an outstanding reliability and capable of recording and reproducing information at a high recording density.

This FeSiAlN film contains respectively 69-85 atomic % of Fe, 5-10 atomic % of Si, 5-10 atomic % of Al and 5-11 atomic % of N.

This FeSiAlN film is a uniform nanocrystalline structure composed of fine crystal grains of a nm order as long as it remains within the range of the composition indicated above, and the average grain diameter is 7 nm or less.

And the surface roughness (Ra) of this SUL 3 is 0.6 nm or less.

When the FeSiAlN film of this SUL 3 is composed as described above, it can be transformed into a uniform nanocrystalline structure composed of fine crystal grains of a nm order. Therefore, it is possible to realize a underlayer having an outstanding flatness and low-noise characteristic, and also to record and reproduce information at a higher recording density.

With regard to this FeSiAlN film, it is possible to change the respective atomic percentage of Fe, Si, Al and N within said range by adopting the composition of the target consisting of a FeSiAl alloy claimed to be near the sendust second peak composition used in spattering and by changing the flow rate of nitrogen (N₂) gas in the mixed gas (inert gas) contained in the nitrogen (N₂) gas and argon (Ar) gas introduced into the chamber.

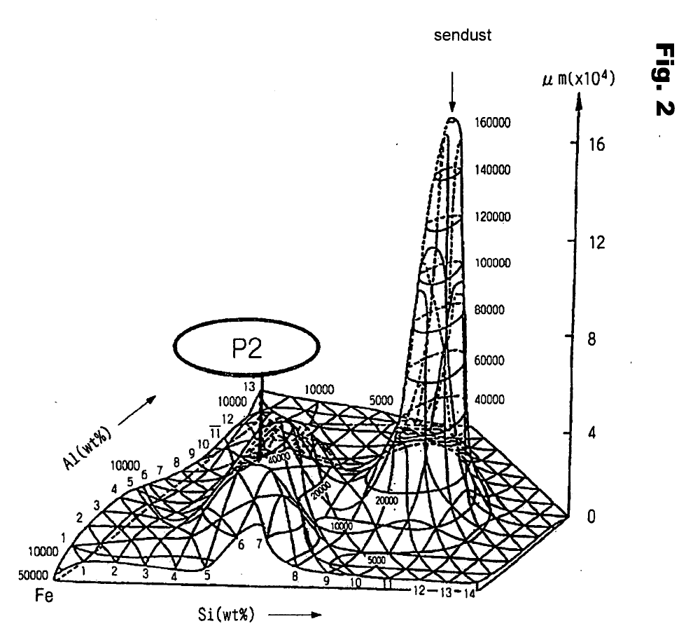

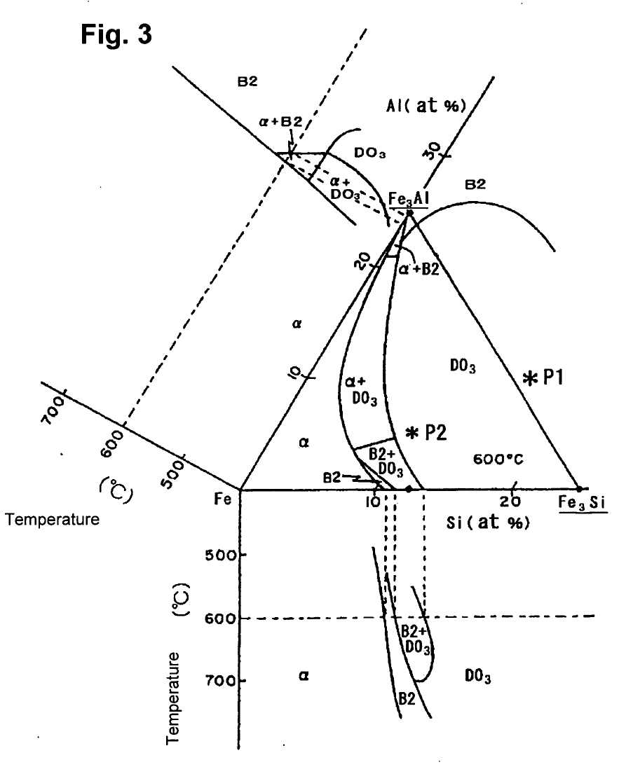

FIG. 2 is a three-dimensional view showing the relationship between the composition of the FeSiAl alloy and its magnetic permeability, and FIG. 3 is a three-dimensional graph showing the state of the FeSiAl alloy, wherein at the first peak (P1) representing the sendust alloy permeability (μm) is high but saturation magnetization (Ms) (not shown) is low. At the so-called second peak of the sendust (P2), on the other hand, permeability (μm) is rather low but saturated magnetization (Ms) is on the contrary high.

Therefore, by choosing the composition near the second peak of the sendust (P2), it is possible to obtain a soft magnetic material with a higher saturation magnetization (Ms) than the sendust alloy (the first peak of the sendust: P1).

Accordingly, a product suitable to as the SUL 3 composed of a soft magnetic FeSiAlN film can be obtained by choosing the composition near the second peak of the sendust (P2), for example, Fe_{81.6}Si_{9.0}Al_{9.4} (atomic %) for the composition of the target, and by sputtering by changing the flow rate of the nitrogen (N₂) gas contained in said mixed gas on this target.

Since the flow rate of nitrogen (N₂) gas in this mixed gas and the composition of the FeSiAlN film directly correspond, it is possible to decide unconditionally the composition of the FeSiAlN film within a range of measuring errors by changing the flow rate of the nitrogen (N₂) gas within the mixed gas.

Suppose that the flow rate of said mixed gas is Fₜₒₜₐₗ and the flow rate of only nitrogen (N2) gas within said mixed gas is F_{N2}, and when the ratio F_{N2}/Fₜₒₜₐₗ of the flow rate of the nitrogen (N₂) gas to the flow rate of the mixed gas F total is changed, the composition of the FeSiAlN film is decided unconditionally.

For example,
if F_{N2}/Fₜₒₜₐₗ=0%, Fe_{83.0}Si_{8.9}Al_{8.1} (atomic %)
if F_{N2}/Fₜₒₜₐₗ=5%, Fe_{79.1}Si_{8.1}Al_{8.5}N_{4.3} (atomic %)
if F_{N2}/Fₜₒₜₐₗ=10%, Fe_{75.2}Si_{9.2}Al_{7.6}N_{8.0} (atomic %)
if F_{N2}/Fₜₒₜₐₗ=15%, Fe_{72.9}Si_{7.8}Al_{8.5}N_{10.8} (atomic %)
and so forth.

In this SUL 3, the banded magnetic domain stabilization energy (E) can be calculated from the hysteresis curve of its magnetic characteristic.

The method of calculating the banded magnetic domain stabilization energy (E) will be described later. However, when said FeSiAlN film is used, the banded magnetic domain stabilization energy (E) can be 1×10³ erg/cm³ or less.

For example, in the case of a FeSiAlN film alloy corresponding to F_{N2}/Fₜₒₜₐₗ=15%, the banded magnetic domain stabilization energy (E) is 2×10² erg/cm³.

As mentioned already, this SUL 3 is made of a soft magnetic FeSiAlN film having a uniform nanocrystalline structure composed of fine crystal grains of a nm order, and therefore its permeability (μm) and saturation magnetization (Ms) are both high, and it has an outstanding soft magnetic characteristic.

In addition, as a result of the adoption of such a nanocrystalline structure, its surface flatness can be maintained even when the film thickness is increased. For example, a flatness represented by a surface roughness of 0.6 nm or less can be realized when the film thickness is within a range of 50-500 nm.

Therefore, the SUL 3 having such an outstanding flatness can reduce magnetic flux leakage from the magnetic pole resulting from the surface roughness and as a result can realize an outstanding low-noise characteristic.

An excessive thickness of the film of this SUL 3 results in increased noises caused said SUL 3. And this will also be a cause of a decline in production efficiency due to a longer deposition time required and an increase in production costs. Therefore, it is preferable to reduce the film thickness to the maximum extent possible. Thus, it is possible to realize perpendicular recording medium having an outstanding low-noise characteristic by reducing the film thickness of the SUL 3.

And since the FeSiAlN film used in this SUL 3 is a material having a high saturation magnetization of 1.3 T or more, the film can be made thinner than the conventional soft magnetic materials such as NiFe crystalline materials, CoZr amorphous materials, etc. And at the same time, it is possible obtain a good noise characteristic.

The thinner the film thickness of this SUL 3 gets, the better results as described above can be obtained. However, when the film thickness is too thin, it will be difficult to converge magnetic flux near the main magnetic pole of the magnetic head therefore limiting any increase in coercive force of the perpendicular recording layer 4 which is characteristic of double-layered mediums. For this reason, the film thickness will be set at the optimum level by taking into account the saturation magnetization (Ms) of the SUL 3 and the magnetomotive force characteristic of the magnetic head combined thereto at the time of writing.

And one or more seedlayer may be formed between this SUL 3 and the substrate 2. By means of such a seedlayer or seedlayers, it is possible to control the magnetic domain structure of the SUL 3. For this seedlayer, for example, materials such as Cr, Ti, CrTi, NiP, etc. can be used although these are not an exhaustive list of materials. By using a seedlayer made of such materials, it is not only possible to prevent the SUL film from pealing off but also to restrict the formation of a magnetic domain structure (banded magnetic domain structure) wherein bands of magnetization in the perpendicular direction develop at almost constant intervals in the SUL 3.

The perpendicular recording layer 4 may consist of a ferromagnetic material the easy axis of which is oriented almost vertically to the film surface. The composition of such materials is not specially limited, and for example CoCr ferromagnetic materials having a hexagonal closest packed structure (hcp) and the easy axis of which is oriented almost vertically to the film surface are preferably used. Such CoCr ferromagnetic materials may contain some other elements as required.

Specific examples of such CoCr ferromagnetic materials include CoCr alloys such as CoCr (Cr<25 at %), CoCrNi, CoCrTa, CoCrPt, CoCrPtTa, CoCrPtB, etc.

And O, SiOₓ, Fe, Mo, V, Si, B, Ir, W, Hf, Nb, Ru or rare earth elements may be added as required for controlling the grain diameter and the segregation among grains of the crystal grains constituting the perpendicular recording layer 4, for controlling the magnetocrystalline anisotropy energy constant Ku^{grain} of the crystal grains, for controlling their corrosion resistance, for adapting to a cryogenic process and so forth.

And in addition to said CoCr alloy, for example CoPt, CoPd, FePt and other thermal decay resistant materials and materials wherein B, N, O, SiOₓ, Zr, and the like are added to pulverize them into fine grains may be used.

And a multilayered perpendicular recording layer formed by laminating multiple layers of Co layer and Pt layer may be applied. As such a multilayered perpendicular recording layer of, a laminated perpendicular recording layer formed by laminating a Co layer and a Pd layer, or a Fe layer and a Pd layer, or one formed by adding B, N, O, Zr, SiOₓ and the like to each of these layers may be applied.

And an intermediate layer may be provided between the perpendicular recording layer 4 and the SUL 3. As the material for this intermediate layer, any material that can transform the perpendicular recording layer 4 formed thereon into a perpendicular magnetization film may be used. And the intermediate layer may be formed to a single-layered structure, a double-layered structure or a multi-layered structure.

This intermediate layer may be of such a structure comprising layers made of a metal material consisting of Ti, Ta, Ru, Cu, Pt, Rh, Ag, Au and other single element metals or alloy materials constituted by adding Cr and the like to any one of these elements, provided that the perpendicular recording layer 4 is made of a CoCr ferromagnetic material.

If the perpendicular recording layer 4 consists of a layer of CoPt, CoPd, FePt and other thermal decay resistant materials or has a multilayered structure including said layer, it may be constituted by including a layer of C, Si, SiN, SiO, PdSiN, AlSiN and the like that promotes the physical, chemical and magnetic isolation of the perpendicular recording layer 4.

If these materials are used for the intermediate layer, coercive force or other factors can be improved. Or one or more types of elements chosen from N, Zr, C, B and the like may be added to these materials to the extent that their crystallinity may not be damaged. The addition of these elements accelerates the minification of crystal grains of the intermediate layer 15, and the effect of improving the recording and reproduction property of the medium can be expected thereby.

The protective layer 5 is designed to protect the surface of the perpendicular recording layer 4, and any material having a mechanical strength, heat resistance, acid resistance, corrosion resistance, etc. required for a protective film can be used, and for example carbon is preferably used although the component material is not specially limited.

And now the method and apparatus for producing the perpendicular recording medium of the present mode of carrying out will be described below.

As a method for producing the perpendicular recording medium 1 of the present mode of carrying out, the sputtering method is preferably used. This sputtering method may include, for example, a transferring-type sputtering method wherein the substrate is placed opposite to the sputtering surface of the target and this substrate is led to move in a direction parallel to the sputtering surface to form a thin film on the surface of said substrate, and a static-type sputtering method wherein the substrate is placed opposite to the sputtering surface of the target for forming a thin film on the surface of the substrate.

The former transferring-type sputtering method is highly productive and therefore is advantageous for the production of low-cost magnetic recording media. On the other hand, the latter static-type sputtering method, due to a stable incident angle of the sputtering particles to the surface of the substrate, enables to produce magnetic recording media having an excellent recording and reproduction characteristic.

The production of perpendicular recording media 1 of the present mode of carrying out, however, is not limited to either one of the transferring-type or the static-type, and they can be used selectively depending on the needs.

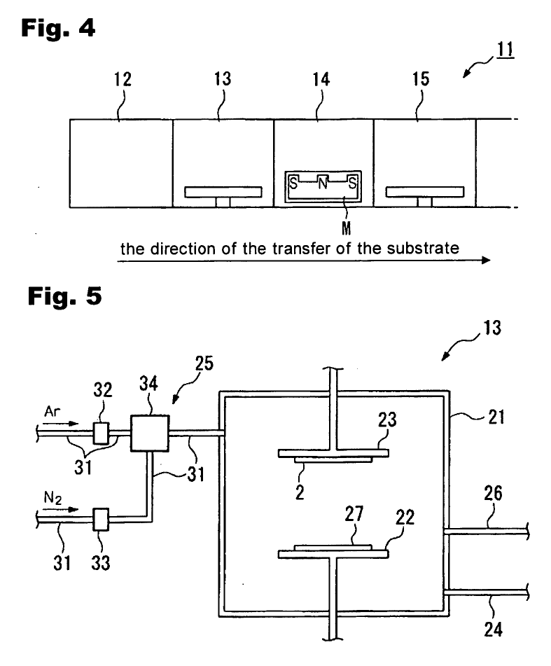

And now, the production of the perpendicular recording medium 1 by means of the production apparatus of the perpendicular recording medium of the present mode of carrying out will be described below in details with reference to FIG. 4.

FIG. 4 is a cross-sectional view showing a sputtering apparatus (production apparatus) to which the static-type sputtering method is applied for producing the perpendicular recording medium of the present mode of carrying out. This sputtering apparatus 11 comprises a load-unload chamber (LC/ULC) 12 for loading and unloading substrates, a first deposition chamber 13 for depositing the SUL 3 on the substrate 2, an anisotropy control chamber 14 for controlling the anisotropy of magnetization by applying magnetic field by means of a magnet M during the heat processing of the SUL 3, and a second deposition chamber 15 for depositing the perpendicular recording layer 4 on the SUL 3.

These LC/ULC 12—the second deposition chamber 15 are arranged in the direction of the transfer of the substrate and each of the LC/ULC 12—the second deposition chamber 15 is provided with transferring means (not shown) for substrates that have been introduced therein, whereby the substrates are transferred in the right direction as shown in the figure, and each of LC/ULC—the second deposition chamber 15 is provided with an exhauster (not shown).

FIG. 5 is a cross-sectional view of the first deposition chamber 13 of the sputtering apparatus 11 of the present mode of carrying out. In the figure, the code 21 is a deposition chamber, the code 22 is a stage serving as the cathode provided near the bottom of the chamber 21, the code 23 is a substrate holder serving as the anode disposed opposite to said stage 22 near the upper part of said chamber 21, the code 24 is a piping for vacuum deaeration connected to a vacuum deaerator (not shown) to create a required vacuum in said chamber 21, the code 25 is a mixed gas introduction apparatus for introducing a mixed gas (an inert gas) composed of nitrogen (N₂) gas and argon gas (Ar) into said chamber 21, and the code 26 is a piping for controlling the exhaust gas.

This stage 22 is provided with a target 27 used for depositing the SUL 3 and composed of, for example, Fe_{83.8}Si_{8.2}Al_{8.5} (atomic %). And the substrate holder 23 contains a temperature controlling means (not shown)for keeping the substrate 2 inserted at a position just opposite said target 27 at a given temperature, for example, in a range of temperature between the room temperature (25° C.) and 200° C.

The mixed gas introduction apparatus 25 comprises an Ar gas flow rate controlling part 32 connected with an Ar gas supply source (not shown) through a piping 31 and containing a mass flow controller for controlling the flow rate of Ar gas, a N₂ gas flow rate controlling part 33 connected with the N₂ gas supply source (not shown) through the piping 31 and containing a mass flow controller for controlling the flow rate of N₂ gas, and a mixed gas supplying part 34 connected with the Ar gas flow rate controlling part 32 and the N₂ gas flow rate controlling part 33 through the piping 31 for mixing the Ar gas and N₂ gas the flow rate of which is controlled and for supplying the resultant mixed gas into the chamber 21 through the piping 31.

This mixed gas introduction apparatus 25 can change the flow rate ratio of N₂ gas in the mixed gas containing N₂ gas and Ar gas introduced into the chamber 21 to a desired flow rate ratio by operating the flow rate controlling parts 32 and 33 and the mixed gas supplying part 34. And in this way it will be possible to change the composition of said SUL 3 in other words the respective atomic percentage of Fe, Si, Al, and N within the range described above.

After the second deposition chamber 15, various processing chambers are provided as required although they are not shown here. They include, for example, a third deposition chamber for depositing the protection film 5 of the perpendicular recording medium 1. And a shutoff valve is provided between each chamber between the LC/ULC 12 and the second deposition chamber 15 to isolate them from the adjacent chamber.

And now the method of producing the perpendicular recording medium according to the present mode of carrying out by using this sputtering apparatus 11 will be described.

Here, a target 27 composed of Fe_{83.8}Si_{8.2}Al_{8.5} (atomic %) for depositing the SUL 3 is previously mounted on the stage 22 in the first deposition chamber 13, a target made of a ferromagnetic material (for example a Co alloy) for depositing the perpendicular recording layer 4 is mounted on the stage in the second deposition chamber 15, and a target for the deposition of the protective layer 5 is mounted on the stage in the third deposition chamber.

To begin with, the substrate 2 is introduced into the LC/ULC 12, and after this LC/ULC 12 is deaerated to a given vacuum, the substrate 2 is transferred to the first deposition chamber 13 by a transferring means (not shown).

In the first deposition chamber 13, the substrate 2 that has been brought in is mounted on the substrate holder 23, and this first deposition chamber 13 is deaerated to a given vacuum while the room temperature is controlled in such a way that the surface temperature of the substrate may be maintained under 200° C. Then, the mixed gas introduction apparatus 25 is operated to fill the chamber 21 with a mixed gas composed of N₂ gas and Ar gas. And the SUL 3 is deposited on the substrate 2 the surface temperature of which has been kept under 200° C.

While depositing this SUL 3, it is possible to change the flow rate ratio of the N₂ gas in the mixed gas F_{N2}/Fₜₒₜₐₗ by separately controlling the Ar gas flow rate controlling part 32 and the N₂ gas flow rate controlling part 33. And it is possible therefore to decide unconditionally the composition of the FeSiAlN film that constitutes the SUL 3.

Any change, for example, in the F_{N2}/Fₜₒₜₐₗ within a range of 5-15% will bring about a change in the composition of the FeSiAlN film within a range from Fe_{79.1}Si_{8.1}Al_{8.5}N_{4.3} (atomic %) to Fe_{72.9}Si_{7.8}Al_{8.5}N_{10.8} (atomic %).

When the deposition of this SUL 3 is completed, the substrate 2 is transferred to the anisotropy control chamber 14, and the SUL 3 on this substrate 2 is placed opposite to the magnet M. This magnet M is put into operation to apply magnetic field on the SUL to heat or cool down the same. This process will induce an easy axis in the radial direction of the substrate 2 in the SUL 3.

Then, the substrate 2 wherein the induction of easy axis has been completed is transferred to the second deposition chamber 15 to deposit the perpendicular recording layer 4.

When the perpendicular recording layer 4 has been deposited, the substrate 2 is transferred to the third deposition chamber (not shown) provided subsequently to the second deposition chamber 15 to deposit the protective layer 5.

The substrate 2 coming out of the process described above is transferred again to the LC/ULC 12, from where it is taken out.

As described, the production apparatus of perpendicular recording media shown in FIGS. 4 and 5 can be used to produce the perpendicular recording medium 1 of the present mode of carrying out.

And now, the perpendicular recording medium 1 of the present mode of carrying out will be described in more details with reference to embodiments and comparative example.

For this description, the perpendicular recording media having the composition shown below were produced.

The production apparatus shown in FIG. 4 and 5 was used to laminate successively a SUL 3 the flow rate ratio F_{N2}/Fₜₒₜₐₗ of which was changed to 5%, 10% and 15%, a perpendicular recording layer 4 and a protective layer 5 on a disk substrate 2 to prepare respective samples, and they were chosen as the samples for the embodiments 1-3. And we prepared also a sample for the case wherein F_{N2}/Fₜₒₜₐₗ=0%, and we adopted this sample as a comparative example.

The fabrication conditions are as follows:

| | |
|---|---|
| Deposition method: | DC magnetron sputtering method |
| Material of the substrate: | Crystallized glass |
| Surface roughness Ra of the | <0.3 nm |
| substrate: | |
| Ultimate vacuum in the deposition | <1 × 10⁻⁷ torr |
| chamber: | |
| Process gas: | Ar gas, N₂ gas |
| Impurity in Ar gas: | <1 ppm |
| Total gas flow rate: | 60 sccm |
| Total gas pressure: | 0.7 Pa |
| N₂ gas flow rate ratio (F_{N2}/Fₜₒₜₐₗ): | 0%, 5%, 10%, 15% |
| Surface temperature of the substrate | Room temperature |
| during deposition: | |
| Thickness of the SUL: | 300 nm |
| Condition for application of magnetic | 600-1,000 Oe in the radial |
| field: | direction of the substrate |
| Cooling condition: | 800 sec |
| Material of the protective layer: | Carbon 7 nm |

Incidentally, the composition of the FeSiAlN film was analyzed by the semi-quantitave analysis method by means of an Auger electronic spectroscopic analyzer (made by Phisical Electronics, PHI-660). To begin with, the carbon (C) protective film in the surface layer of the sample was removed by means of Ar ion sputtering, and then their spectroscopic profiles in the range of 0-2,200 eV were measured. The measuring conditions were as follows:

(1) Electronic gun for excitation

| | | |
|---|---|---|
| Acceleration voltage: | 10 | kV |
| Sample current: | 200 | nA |
| Analysis zone: | 80 × 74 | μm |

(2) Ion gun for Ar ion sputtering

| | | |
|---|---|---|
| Acceleration voltage: | 1 | kV |
| Sputtering speed: | 1.0 | nm (value converted into SiO₂) |
| Sputtering film thickness: | 30 | nm (value converted into SiO₂) |

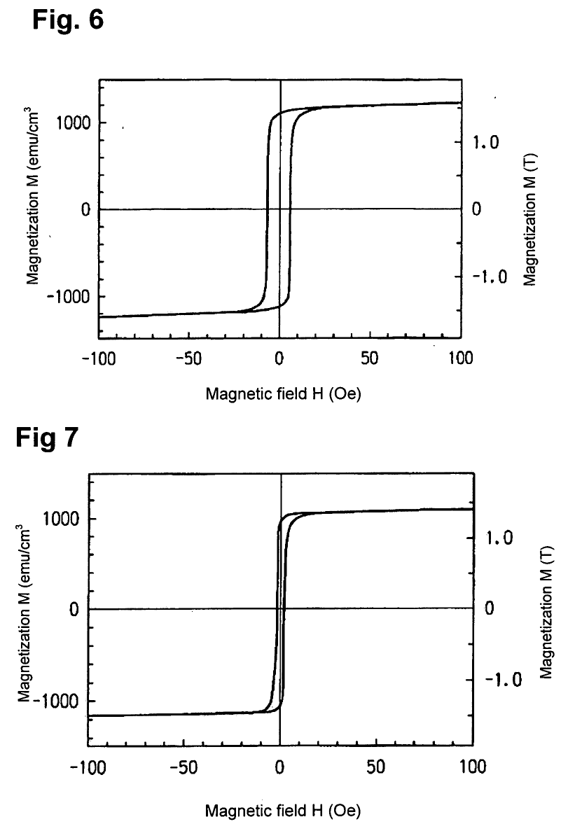

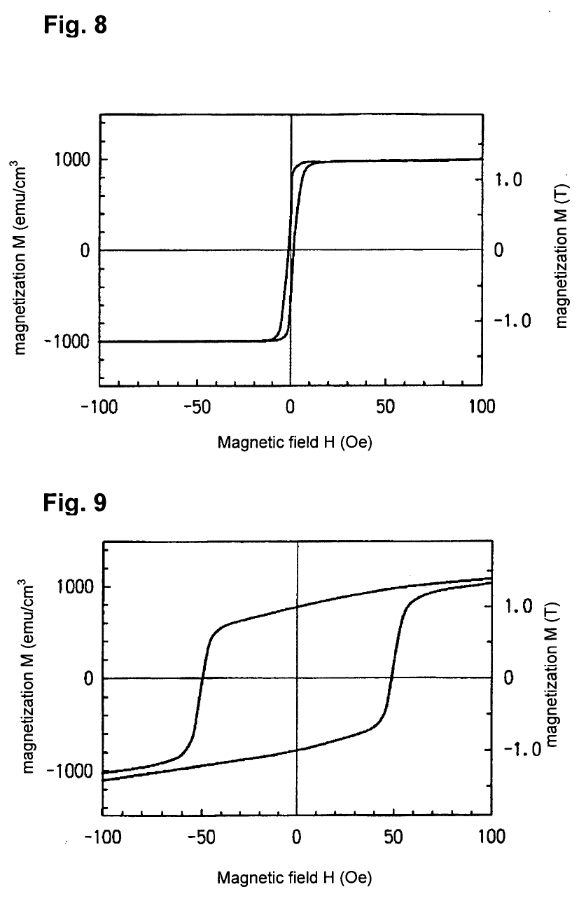

The magnetic characteristics for each sample for the embodiments 1-3 and the comparative example obtained by the procedure described above were evaluated. As the instrument of measurement, a vibration sample-type magnetometer (VSM, made by Riken Denshi K.K., BHV-35) was used. The measurements are shown in FIGS. 6-9. These figures show the magnetization curves of the substrate 2 in the radial direction.

FIGS. 6-9 show that, as far as embodiments 1-3 are concerned, any increase in the contents ratio of N in the FeSiAlN film results in a decrease in Hc of the SUL 3 leading to an excellent soft magnetic property.

The measurements obtained from the comparative example, on the other hand, show that any drop in the strength of magnetic field impressed to below 50 Oe results to a considerable decline in the magnetization level in the direction of the magnetic field impressed and an increase in the Hc of the SUL 3, and that a banded magnetization domain structure has been formed in the film.

As a result, it was found that changing the flow rate of N₂ gas is an effective means for controlling precisely the contents ratio of N in the FeSiAlN film, for controlling very easily the coercive force of the SUL 3 and for obtaining a good soft magnetic property.

And measurements conducted by changing the temperature of substrate showed that the FeSiAlN film produced at a temperature of the base substrate higher than 200° C. had an increased coercive force and that they had no good soft magnetic property.

In addition, it was found that the surface roughness Ra of the embodiments 1-3 was respectively 0.60, 0.53 and 0.34, that Ra of any sample could be suppressed to 0.6 nm or less and that there was almost no deterioration in the surface roughness of the substrate 2.

Lately it was found that the magnitude of coercive force of the SUL 3 of double-layered media can affect greatly the improvement of the floating magnetic field resistance of perpendicular recording media, and the control or the elimination of magnetic walls formed in the SUL has become an important issue. As solutions for this issue, attempts have been made to transform the whole underlayer into a single magnetic domain of easy axis in the radial direction by adopting a underlayer structure wherein an anti-ferromagnetic layer is provided under a SUL or adopting a underlayer structure wherein an anti-ferromagnetic layer and a soft magnetic layer are laminated. It has been known generally that, in a laminated film made by laminating a magnetic material having an outstanding soft magnetic property and a small coercive force and an anti-ferromagnetic material, a strong interfacial exchange coupling works between the anti-ferromagnetic layer and the ferromagnetic layer. Therefore, for transforming the underlayer into a single magnetic domain by taking advantage of the interlayer coupling between magnetic layers as mentioned above, the underlayer material of the present mode of carrying out capable of reducing coercive force is very effective. In other words, the underlayer material of the present mode of carrying out enables to design a perpendicular recording medium having an excellent floating magnetic field resistance and is suitable for use on a magnetic recording apparatus for recording and reproducing at a high recording density.

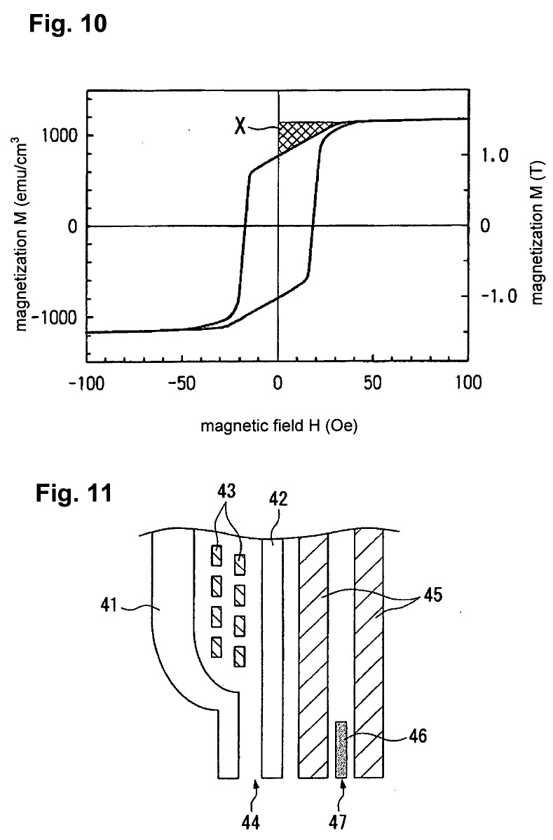

And, in the case of a SUL having magnetization curves as those shown in FIG. 10, images of observation by a scanning magnetic force microscope show that a banded or maze magnetic domain has been formed due to the development of a perpendicular magnetic anisotropy in the film. The stabilization energy E of such a banded magnetic domain structure, equal to the work load for causing a shift from the residual magnetization state to the state of transformation into a single magnetic domain, is defined to be equal to the area of the zone X shown in FIG. 10. It is possible to use this value to evaluate quantitatively the stabilization energy of the banded magnetic domain of the SUL.
(Formula 1)

$$E = ( 2 {πM}_{s}^{2} - \frac{{K}_{u} h}{2 λ} + \frac{2 {π}^{2} Ah}{{λ}^{3}} ) {θ}_{0}^{2}$$

The first term at the right hand of this formula represents the magnetostatic energy, the second term represents the perpendicular magnetic anisotropic energy, and the third term represents the exchange energy.

Provided that;
λ: Wavelength of a band of the banded magnetic domain structure
Ku: Perpendicular magnetic anisotropy constant
h: Film thickness of the SUL
A: Exchange constant
θ₀: Transient build-up angle

The measurements of the stabilization energy of the SUL by the means described above showed that the stabilization energy of the banded magnetic domain for the embodiments 1-3 was 1×10³ erg/cm³ or less, and the stabilization energy of the banded magnetic domain for the comparative example was 7×10⁴ erg/cm³.

If the above results and the evaluation of the medium described further down below show that the stabilization energy of the banded magnetic domain obtained by the hysteresis curve of the magnetic property of the SUL 3 is 1×10³ erg/cm³ or less, it will be concluded that a medium of an outstanding noise property has been obtained.

And then the medium noise Nm (μVrms) for each sample of the embodiment 3 and the comparative example was measured.

FIG. 11 is a cross-sectional view of an integrated read and write film head used for this measurement. In the figure, the code 41 represents an upper electrode, the code 42 represents a lower electrode, the code 43 represents a write coil, the code 44 represents a write gap, the code 45 represents a shield, the code 46 represents a MR component part and the code 47 represents a read gap.

With regard to reading, the medium noise was measured under the following measurement conditions by means of a MR head (Magnetic Resistance Head).

[Measuring Instruments]

Spin stand: LS90S (trade name) made by Kyodo Denshi K.K.
Media tester: RWA 2550 ++ (trade name) by GUZIK
Read head (GMR head): track width (Tw): 0.25 μm
Radius of measurement on the disk: 22.55 mm
Disk rotating speed: 4,200 rpm

The medium noise Nm was calculated by integrating the differential spectrum obtained by removing the system noise spectrum from the reproduced signal spectrum within a range of 1-100 MHz.

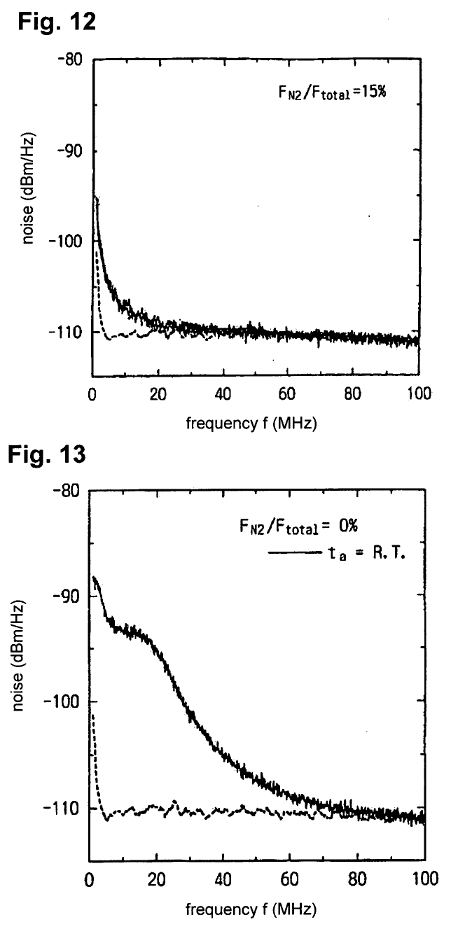

FIG. 12 is a graph showing the result of measuring the noise spectrum of the embodiment 3. FIG. 13 is a graph showing the result of measuring the noise spectrum of the comparative example. Incidentally, the broken line in the figure represents the system noise spectrum in the background (BG).

These figures show that, on the sample of the embodiment 3, the medium noise Nm decreases exponentially from 1 MHz and at 40 MHz or more it goes down to below −110 dBm/Hz. On the other hand, in the case of the sample of the comparative example, the noise reaches the maximum point in the vicinity of 10-20 MHz due to the banded magnetic domain structure and then above 80 MHz the noise decrease falling down below −110 dBm/Hz. Moreover, the calculated medium noise Nm of the samples of the embodiments 1-3 was respectively 83, 35, and 19 μVrms, and it was confirmed that they represented low noise levels than the evaluated value of 110 μVrms for the comparative example.

On the other hand, as the result obtained on the comparative example shows, the formation of a banded magnetic domain results in an increase in the medium noise and therefore its suppression is sought. In addition, the conventional permalloy and sendust materials have the equivalent or stronger noise characteristics than the comparative example and this proves that the material of the present invention has a low noise characteristic. Therefore, the use of a sample composed of FeSiAlN for the underlayer will result in the realization of an outstanding recording and reproduction property accompanied with a low noise property.

And the evaluation of various FeSiAlN underlayer films with different compositions revealed that the medium noise level can be contained to 100μ Vrms or lower if such films are composed of 69-85 atomic % of Fe, 5-10 atomic % of Si and 5-10 atomic % of Al.

And now, magnetic recording apparatuses having the perpendicular recording medium of the present mode of carrying out shall be described with reference to drawings.

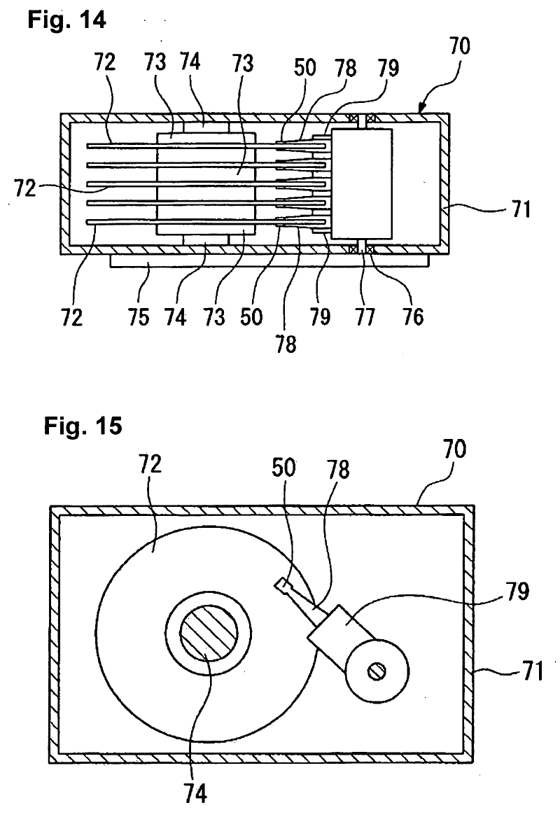

FIG. 14 is a cross-sectional view of a hard disk drive (a magnetic recording apparatus) of the present mode of carrying out. FIG. 15 is a plane view of the magnetic recording layer shown in FIG. 14, wherein the code 50 represents a magnetic head, the code 70 represents a hard disk drive, the code 71 represents a housing, the code 72 represents a perpendicular recording medium, the code 73 represents a spacer, the code 78 represents a suspension and the code 79 represents a swing arm.

This hard disk drive 70 is externally constituted by a rectangular housing 71 having an internal space to house discoidal perpendicular recording media 72, a magnetic head 50 and other elements. This housing 71 contains inside a plurality of perpendicular recording media 72 skewered alternatively with spacers 73 on a spindle 74. And the housing 71 contains a bearing (not shown) for the spindle 74, and on the outside of the housing 71 there is a motor 75 for rotating the spindle 74. By this configuration, all the perpendicular recording media 72 are kept rotatively around the spindle 74 all being bundled together while leaving intervals with spacers 73 for allowing the approach of magnetic heads 50.

In the housing 71 and beside the perpendicular recording medium 72, there is a rotary shaft 77 called “rotary actuator” being supported by the bearing 76 in parallel with the spindle 74. This rotary shaft 77 is provided with a plurality of swing arms 79 protruding in the space between each perpendicular recording medium 72. At the tip of each swing arm 79, a magnetic head 50 is fixed through a slender triangular suspension 78 fixed diagonally opposite to the surface of each perpendicular recording medium 72 located above or below the same.

This magnetic head 50 is provided with a recording element for writing information on the perpendicular recording medium 72 and a reproduction element for reading information from the perpendicular recording medium 72.

As described above, any hard disk drive 70 provided with a perpendicular recording medium of the present mode of carrying out can realize a lower noise level than the conventional permalloy or sendust crystalline materials and can record and reproduce information at a high recording density.

This hard disk drive 70 can write desired magnetic information on a perpendicular recording medium 72 by rotating the perpendicular recording medium 72, by moving the swing arm 79, by approaching the magnetic head 50 fixed on said swing arm 79 to the perpendicular recording medium 72, and by causing the magnetic field generated by this magnetic head 50 act on the perpendicular recording layer of the perpendicular recording medium 72.

It also can read magnetic information by moving the swing arm 79 and the magnetic head 50 to an optional position on the perpendicular recording medium 72 and by detecting the leakage magnetic field from the perpendicular recording layer constituting the perpendicular recording medium 72 by means of the reproduction element of the magnetic head.

The use of this hard disk drive 70 wherein a perpendicular recording medium 72 provided with a SUL 3 is used can realize a lower noise level than the conventional permalloy or sendust crystalline materials and can record and reproduce information at a high recording density.

Therefore, it is possible to provide a hard disk drive 70 capable of recording and reproducing magnetic information with stability at a high recording density.

Incidentally, although this hard disk drive 70 is constituted by a plurality of perpendicular recording media 72 and spacers 73 alternatively skewered by a spindle 74, any number of more than one perpendicular recording media 72 may be used here and the present invention is not limited to the construction described above.

And the number of magnetic heads 50 mounted may be any number of more than one. And the shape and driving system of the swing arm 79 are not limited to those shown in FIGS. 14 and 15, and the linear driving system or any other system may obviously be adopted.

As described above, the perpendicular recording medium of the present mode of carrying out, constituted by laminating the substrate 2, the SUL 3, the perpendicular recording layer 4 and the protective layer 5 in the upward direction and the SUL 3 being composed of a soft magnetic material having a composition of FeSiAlN, can realize a lower noise level than the conventional permalloy or sendust crystallized materials and can easily and correctly record and reproduce information at a high recording density.

According to the magnetic recording apparatus of the present mode of carrying out wherein the perpendicular recording medium of the present mode of carrying out is used, it is possible to provide a magnetic recording apparatus capable of recording and reproducing information at a higher recording density.

According to the production method of the perpendicular recording media of the present mode of carrying out, wherein a target 27 consisting of a FeSiAl alloy and a mixed gas with various flow rate ratio of N₂ gas F_{N2}/Fₜₒₜₐₗ are used to deposit on the substrate the surface temperature of which is kept not higher than 200° C., the composition of the FeSiAlN film constituting the SUL 3 can be varied considerably.

And the SUL 3 formed constitutes a uniform nanocrystalline structure of an nm order and therefore it is possible to produce a perpendicular recording medium 1 having an outstanding low noise property by a low temperature process.

According to the production apparatus of the perpendicular recording medium of the present mode of carrying out, wherein the first deposition chamber 13 is provided for introducing a target 27 consisting of a FeSiAl alloy and a mixed gas with a various flow rate ratio of N₂ gas F_{N2}/Fₜₒₜₐₗ to deposit the SUL 3 on the substrate 2 the surface temperature of which is kept not higher than 200° C., it is possible to control with a high precision the contents ratio (atomic %) of N contained in FeSiAlN constituting the SUL 3 within the limits of material composition for displaying an outstanding low noise property. Therefore, it is possible to obtain with a good reproducibility and easily a SUL 3 composed of FeSiAlN having a good low noise property.

Industrial Applicability

As described in details above, according to the perpendicular recording medium of the present invention, wherein a soft magnetic material composed of FeSiAlN for the SUL of a double-layered medium comprising a SUL and a perpendicular recording layer, it is possible to realize a lower noise level than the conventional permalloy or sendust crystalline materials and to record and reproduce accurately and easily information at a high recording density.

According to the magnetic recording apparatus of the present invention, wherein the perpendicular recording medium of the present invention is used, it is possible to provide a magnetic recording apparatus capable of recording and reproducing information at a higher recording density.

According to the production method of the perpendicular recording medium of the present invention, comprising a process of forming a SUL by depositing a base material containing at least Fe, Si and Al and an inert gas containing nitrogen (N₂), it is possible to deposit a SUL of a uniform nanocrystalline structure composed of fine crystal grains of an nm order on the substrate, and as a result it is possible to obtain a perpendicular recording medium having an outstanding low noise property by a low-temperature process.

According to the production apparatus of the perpendicular recording medium of the present invention comprising a deposition chamber or chambers into which a base material containing at least Fe, Si and Al and an inert gas containing nitrogen (N₂) gas are introduced to deposit said SUL on the substrate the surface temperature of which is kept not higher than 200° C., it is possible to control with a high precision the contents ratio (atomic %) of N contained in FeSiAlN constituting the SUL within the limits of material composition appropriate for displaying an outstanding low noise property by controlling the flow rate of an inert gas containing nitrogen (N₂) gas to be introduced into said deposition chambers. Therefore, it is possible to obtain with a good reproducibility and easily a SUL composed of FeSiAlN having an outstanding low-noise property.

1. A perpendicular recording medium comprising a soft magnetic underlayer (hereinafter referred to as “SUL”) and a perpendicular recording layer formed on said SUL, wherein said SUL consists of a soft magnetic material composed of FeSiAlN.

2. The perpendicular recording medium according the claim 1, wherein said soft magnetic material contains 5-11 atomic % of N.

3. The perpendicular recording medium according to claim 2, wherein said soft magnetic material contains respectively 69-85 atomic % of Fe, 5-10 atomic % of Si and 5-10 atomic % of Al.

4. The perpendicular recording medium according to claims 1, wherein the average diameter of the crystal grains of said SUL is 7 nm or less.

5. The perpendicular recording medium according to claim 1, wherein the stabilization energy of the banded magnetic domain obtained from the hysterisis curves of the magnetic property of said SUL is 1×10³ erg/cm³ or less.

6. The perpendicular recording medium according to claim 1, wherein surface roughness of said SUL is 0.6 nm or less when the film thickness thereof is within the limits of 50-500 nm.

7. A magnetic recording apparatus comprising the perpendicular recording medium according to claim 1.

8. A method of producing perpendicular recording media each comprising a SUL and a perpendicular recording layer formed on said SUL, wherein
the process of forming said SUL consists of depositing on the substrate the surface temperature of which is kept not higher than 200° C., a base material containing at least Fe, Si and Al and an inert gas containing nitrogen (N₂) gas.

9. An apparatus for producing perpendicular recording media each comprising a SUL and a perpendicular recording layer formed on said SUL, wherein
a deposition chamber or chambers is or are provided for introducing therein a base material containing at least Fe, Si and Al and an inert gas containing nitrogen (N₂) gas and for depositing said SUL on the substrate the surface temperature of which is kept not higher than 200° C.

10. The apparatus for producing perpendicular recording media according to claim 9, wherein said deposition chamber or chambers is or are provided with a control means for controlling the surface temperature of said substrate.
